(19) United States
(12) Patent Application Publication
(10) Pub. No.: US 2018/0221224 A1
(43) Pub. Date: Aug. 9, 2018

(54) DUAL DEPLOYMENT RAMP

(71) Applicant: ElDorado Mobility, Longview, TX (US)

(72) Inventors: Matthew Lee Smith, Salina, KS (US); Arjun Kumar Gopal, Troy, MI (US)

(21) Appl. No.: 15/888,346

(22) Filed: Feb. 5, 2018

Related U.S. Application Data
(60) Provisional application No. 62/454,584, filed on Feb. 3, 2017.

(51) Int. Cl. A61G 3/06; B65G 69/28; B60P 1/43

(52) U.S. Cl. CPC A61G 3/061; B60P 1/43; B65G 69/287

(57) ABSTRACT

The present disclosure provides dual deployment ramps (and related ramp systems) for a vehicle, the ramps comprising a ramp assembly, the ramp assembly comprising a mid-panel and a first and second end-panel, the end-panels pivotably attached to opposite ends of the mid-panel; a slide cable comprising a first and second end, the first end engaging the first end-panel and the second end engaging the second end-panel; opposing roller plate assemblies comprising one or more pulleys for engagement of the slide cable, the roller plate assemblies positioned below the ramp assembly and at each end thereof below the respective first and second end-panel; and a cable drum assembly positioned below the ramp assembly and between the opposing roller plate assemblies, the cable drum assembly comprising a cable drum engaging the slide cable to provide reversible movement to the slide cable for pulling one of the first and second end-panels to move the ramp assembly in one of opposing directions for providing dual deployment. The present disclosure also provides vehicles comprising the ramps and ramp systems described herein.

### CROSS-REFERENCE TO A RELATED APPLICATION

This application claims the benefit of U.S. Provisional Application Ser. No. 62/454,584 filed Feb. 3, 2017, which is hereby incorporated by reference in its entirety.

### BACKGROUND

Current wheelchair accessible vehicles have only one side deployment, either curb-side or driver-side of the vehicle. This deployment arrangement can limit one's parking options, as the driver has to always choose parking locations that will allow deployment on the required side of the vehicle. Further, current solutions tend to be bulky when in the retracted position, resulting in limited space for occupants within the vehicle.

### BRIEF SUMMARY

The present disclosure provides a dual deployment ramp for vehicles, e.g., buses, vans and sport utility vehicles, that can retractably deploy a ramp to either side of a vehicle for wheelchair entry and exit.

In one aspect, the present disclosure provides a dual deployment ramp for a vehicle, the ramp comprising a ramp assembly, the ramp assembly comprising a mid-panel and a first and second end-panel, the end-panels pivotably attached to opposite ends of the mid-panel; a slide cable comprising a first and second end, the first end engaging the first end-panel and the second end engaging the second end-panel; opposing roller plate assemblies comprising one or more pulleys for engagement of the slide cable, the roller plate assemblies positioned below the ramp assembly and at each end thereof below the respective first and second end-panel; and a cable drum assembly positioned below the ramp assembly and between the opposing roller plate assemblies, the cable drum assembly comprising a cable drum engaging the slide cable to provide reversible movement to the slide cable for pulling one of the first and second end-panels to move the ramp assembly in one of opposing directions for providing dual deployment.

In another aspect, the present disclosure provides a dual deployment ramp system for a vehicle, comprising a ramp assembly, the ramp assembly comprising a mid-panel and a first and second end-panel, the end-panels pivotably attached to opposite ends of the mid-panel; a slide cable comprising a first and second end, the first end engaging the first end-panel and the second end engaging the second end-panel; opposing roller plate assemblies comprising one or more pulleys for engagement of the slide cable, the roller plate assemblies positioned below the ramp assembly and at each end thereof below the respective first and second end-panel; and a cable drum assembly positioned below the ramp assembly and between the opposing roller plate assemblies, the cable drum assembly comprising a cable drum driven by a reversible motor, the cable drum engaging the slide cable to provide reversible movement to the slide cable for pulling one of the first and second end-panels to move the ramp assembly in one of opposing directions for providing dual deployment.

In another aspect, the present disclosure provides a vehicle comprising a dual deployment ramp or system as described herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an exploded view of an embodiment of a dual deployment ramp of the present disclosure.

FIG. 2 shows a bottom view of a ramp assembly of an embodiment of a dual deployment ramp of the present disclosure.

FIG. 3 shows a perspective view of a roller plate assembly of an embodiment of a dual deployment ramp of the present disclosure.

FIG. 4 shows a top view of a top plate assembly of an embodiment of a dual deployment ramp of the present disclosure. A portion of FIG. 4 illustrates a cut-away showing a portion of the roller plate assembly aligned below the top plate assembly and ramp assembly.

FIG. 5 shows a perspective view of a cable drum assembly of an embodiment of a dual deployment ramp of the present disclosure.

FIG. 6 shows a bottom view of a ramp assembly and a partial bottom view of a roller plate assembly, with a slide cable interacting with both assemblies, of an embodiment of a dual deployment ramp of the present disclosure.

FIG. 7 shows a top view of a ramp assembly of an embodiment of a dual deployment ramp of the present disclosure.

FIG. 8 shows a top view of a ramp support and slide plates of an embodiment of a ramp assembly of the present disclosure.

FIG. 9 shows a bottom perspective view of a mid-panel of a ramp assembly of an embodiment of a dual deployment ramp of the present disclosure.

FIG. 10 shows a dual deployment ramp of the present disclosure as deployed on the passenger side of a vehicle.

FIG. 11 shows a dual deployment ramp of the present disclosure as deployed on the driver side of a vehicle.

### DETAILED DISCLOSURE

Aspects of the present disclosure provide dual deployment ramps for vehicles, e.g., buses, vans and sport utility vehicles, that can retractably deploy a ramp to either side of the vehicle for wheelchair entry and exit. As such, the disclosure provides fully functional in-floor ramps that deploy on both sides of the vehicle.

In one aspect, the present disclosure provides dual deployment ramps for a vehicle, the ramps comprising a ramp assembly, the ramp assembly comprising a mid-panel and a first and second end-panel, the end-panels pivotably attached to opposite ends of the mid-panel; a slide cable comprising a first and second end, the first end engaging the first end-panel and the second end engaging the second end-panel; opposing roller plate assemblies comprising one or more pulleys for engagement of the slide cable, the roller plate assemblies positioned below the ramp assembly and at each end thereof below the respective first and second end-panel; and a cable drum assembly positioned below the ramp assembly and between the opposing roller plate assemblies, the cable drum assembly comprising a cable drum engaging the slide cable to provide reversible movement to the slide cable for pulling one of the first and second end-panels to move the ramp assembly in one of opposing directions for providing dual deployment.

In one embodiment, the dual deployment ramps further comprise a top plate assembly positioned above the ramp assembly when the ramp assembly is in a stowed position. In some embodiments, the ramp assemblies are capable of deploying from underneath either longitudinal end of the top plate assembly.

In another embodiment, the dual deployment ramps may further comprise one or more mid-panel side rails positioned on the outer edges of the mid-panel and running substantially the longitudinal length of the mid-panel.

In another embodiment, the dual deployment ramps may further comprise one or more end-panel side rails positioned on the outer edges of each of the end-panels.

In another embodiment, the dual deployment ramps may comprise one or more ramp support on the underside of the mid-panel and running substantially the longitudinal length of the mid-panel. In some embodiments, the dual deployment ramps may also comprise one or more slide plate disposed on each of the one or more ramp support. In some embodiments, the dual deployment ramps may comprise one or more positioning spring extending outwards from each end of the ramp support to respective end-panels.

In another embodiment, the end-panels are pivotably attached to opposite ends of the mid-panel via one or more spring loaded hinge.

In another aspect, the present disclosure provides dual deployment ramp systems for a vehicle, the systems comprising a ramp assembly, the ramp assembly comprising a mid-panel and a first and second end-panel, the end-panels pivotably attached to opposite ends of the mid-panel; a slide cable comprising a first and second end, the first end engaging the first end-panel and the second end engaging the second end-panel; opposing roller plate assemblies comprising one or more pulleys for engagement of the slide cable, the roller plate assemblies positioned below the ramp assembly and at each end thereof below the respective first and second end-panel; and a cable drum assembly positioned below the ramp assembly and between the opposing roller plate assemblies, the cable drum assembly comprising a cable drum driven by a reversible motor, the cable drum engaging the slide cable to provide reversible movement to the slide cable for pulling one of the first and second end-panels to move the ramp assembly in one of opposing directions for providing dual deployment.

In one embodiment, the dual deployment ramp systems further comprise a top plate assembly positioned above the ramp assembly when the ramp assembly is in a stowed position, in some embodiments, the ramp assembly is capable of deploying from underneath either longitudinal end of the top plate assembly.

In another embodiment, the dual deployment ramp systems may further comprise one or more mid-panel side rails positioned on the outer edges of the mid-panel and running substantially the longitudinal length of the mid-panel.

In another embodiment, the dual deployment ramp systems may further comprise one or more end-panel side rails positioned on the outer edges of each of the end-panels.

In another embodiment, the dual deployment ramp systems may further comprise one or more ramp support on the underside of the mid-panel and running substantially the longitudinal length of the mid-panel. In some embodiments, the dual deployment ramp systems may also comprise one or more slide plate disposed on each of the one or more ramp support. In some embodiments, the dual deployment ramp systems may comprise one or more positioning spring extending outwards from each end of the ramp support to respective end-panels.

In another embodiment, the end-panels are pivotably attached to opposite ends of the mid-panel via one or more spring loaded hinge.

In further aspects, the present disclosure provides vehicles comprising the dual deployment ramps and/or dual deployment ramp systems as described herein.

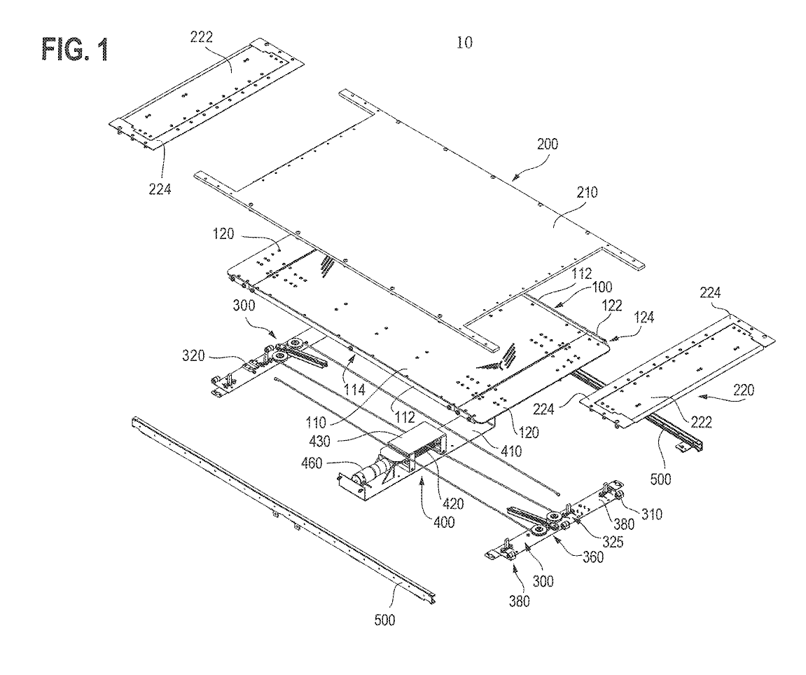

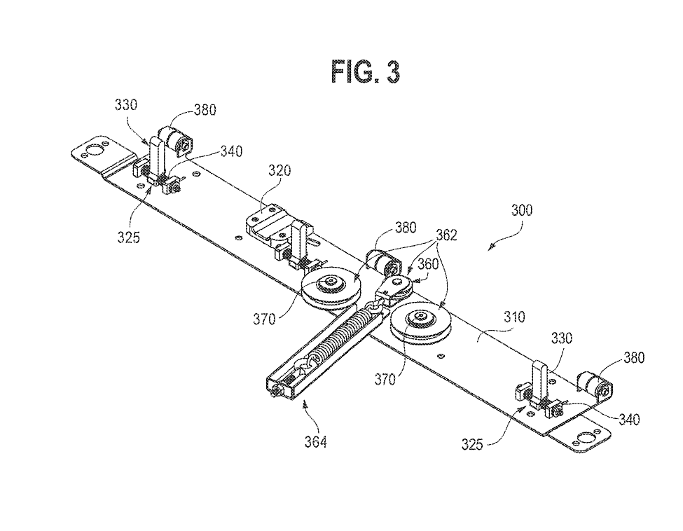

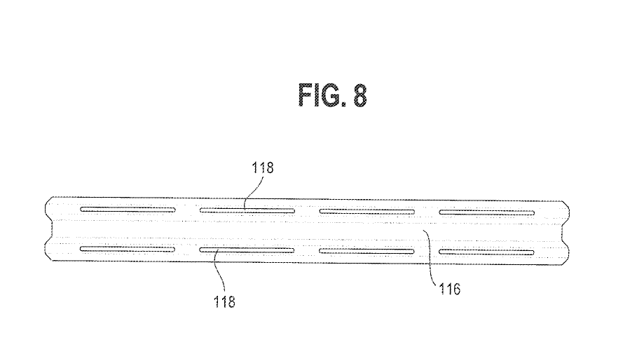

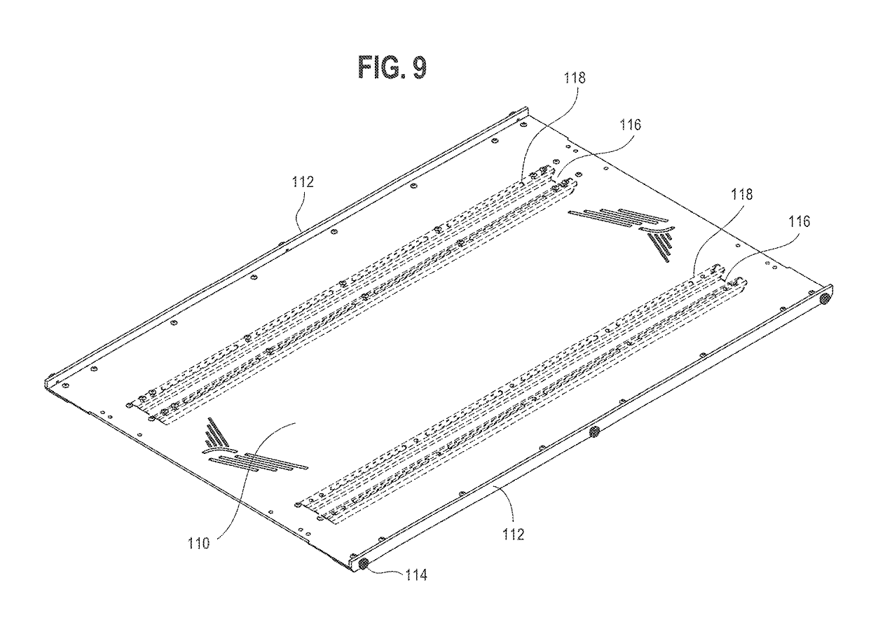

As shown in FIGS. 1-9, in at least one embodiment, a dual deployment ramp 10 of the present disclosure comprises a ramp assembly 100, a top plate assembly 200, a roller plate assembly 300, and a cable drum assembly 400. The ramp assembly 100 comprises a mid-panel 110 with end-panels 120 pivotably connected thereto at each longitudinal end of the mid-panel. Further, the mid-panel 110 can have mid-panel side rails 112 attached on the outer edges of the mid-panel and running substantially the longitudinal length of the mid-panel. Likewise, the end-panels 120 can include end-panel side rails 122 attached to the outer edges of the end-panels and that abut the longitudinal ends of the mid-panel side rails 112 and extend to the end of the end-panels 120. There can also be rollers 114, 124 at various positions along the lengths of both the mid-panel side rails 112 and the end-panel side rails 122 to provide a sliding feature to the ramp assembly.

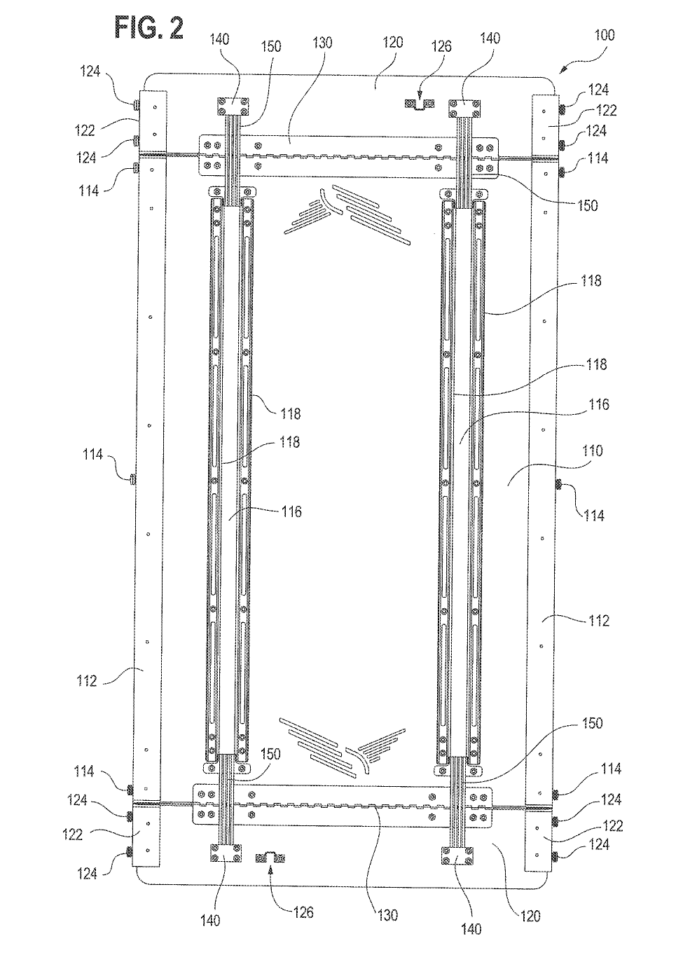

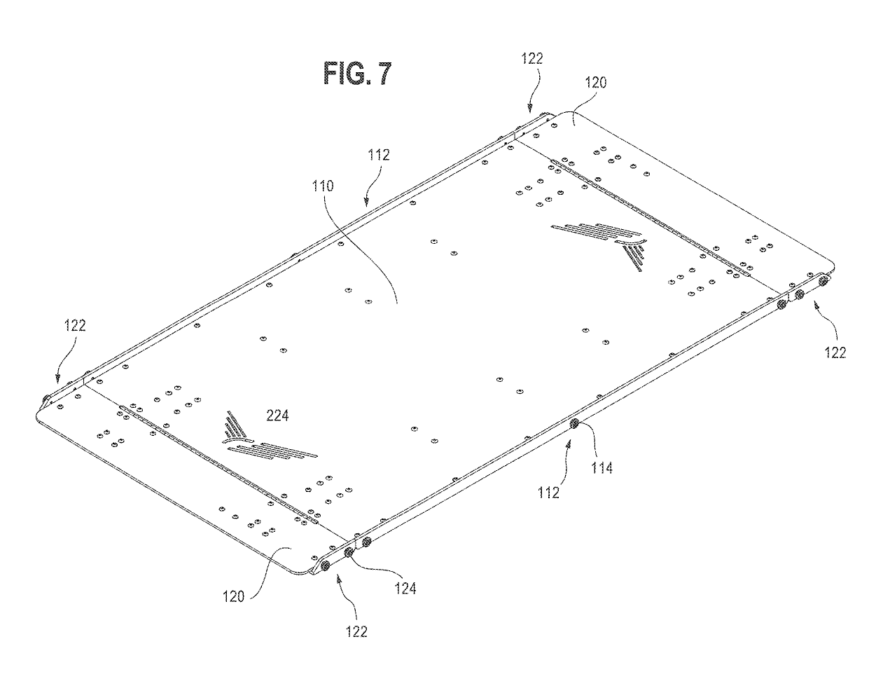

As shown in FIGS. 2, 6, 8 and 9, the underside of the mid-panel 110 of the ramp assembly 100 comprises ramp supports 116 and slide plates 118. Each of the end-panels 120 may also attach to the respective ends of the mid-panel 110 via a pivotable connection, such as, e.g., a hinge 130. In some embodiments, the hinge may attach to the top-sides of the end-panels and mid-panel. The pivotable connection between the mid- and end-panels can be spring loaded (such as, but not limited to a spring loaded hinge) so as to maintain linear alignment of the end-panels relative to the mid-panel when not under a stress; however, the end-panels can pivot under stress (i.e., once the ramp assembly 100 is deployed, gravity forces the ramp downwards at an angle relative to the ground, forcing the mid-panel to pivot downward. The mid- and end-panel connection on the opposite end of the ramp assembly maintains a linear plane with the mid-panel while the end-panel is at the ground position. In the embodiment illustrated, the assembly comprises two ramp supports attached to the underside of the mid-panel and spaced evenly apart, running lengthwise along the mid-panel. The ramp supports can provide an attachment for one or more positioning spring 150 (such as, but not limited to, a spring steel) for providing the spring loaded pivotable connection between the mid- and end-panels. The positioning springs 150 can extend outwards from each end of the ramp supports 116 and attach to spring clamps 140 which are attached to each of the end-panels 120. The spring clamps 140 can be disposed in opposing positions on each of the end-panels 120 in alignment with and connected to the ramp supports 116 (via the positioning springs 150). A top view of the ramp assembly 100 is shown in FIG. 7.

As further shown in FIG. 2, the underside of each of the end-panels 120 may have a slide cable attachment bracket 126. Each of the slide cable attachment brackets 126 can be positioned diagonally relative to each other on respective end-panels 120. The slide cable attachment brackets 126 provide for attachment points for opposing ends of a slide cable 125, which will be further described herein.

Referring to FIGS. 1, 3 and 6, the dual deployment ramp 10 can also have a roller plate assembly 300. The roller plate assembly 300 is positioned below the ramp assembly 100. The roller plate assembly comprises opposing roller plate weldments 310 which can be attached to a vehicle wherein the ramp 10 is installed. The roller plate weldments 310 can each have a cable saddle 320 a kick stand assembly 325 comprising a kick stand mount 340, a kick stand block 330, and kick stand torsion spring 350. There can be more than one kick stand assemblies. The kick stand block 330 pivotably attaches to the kick stand mount 340 and interacts with the kick stand torsion spring 350 such that the kick stand block 330 maintains a vertical position relative to the plane of the roller plate weldment 310 when the spring is uncompressed. If the kick stand assembly 325 is engaged as to be described herein, the kick stand torsion spring 350 is compressed, allowing for the kick stand block 330 to lay substantially horizontal relative to the plane of the roller plate weldment 310.

The roller plate assembly 300 may further comprise a pulley assembly 360 attached to each of the opposing roller plate weldments 310 such that the pulley assemblies are diagonally disposed relative to each other on respective weldments 310. The pulley assemblies 360 can comprise multiple pulleys 362 attached to the roller plate weldment 310 via one or more pulley shafts 370, wherein at least one of the pulleys 362 interacts with a tension chute 364 to provide constant tension to the ramp cable 150 via the pulleys 362. The tension chute 364 may include a spring therein to provide the tension. Further, the roller plate weldment 310 may have one or more rollers 380 attached thereto to provide ease of movement of the ramp assembly 100 across each of the roller plate assemblies 300.

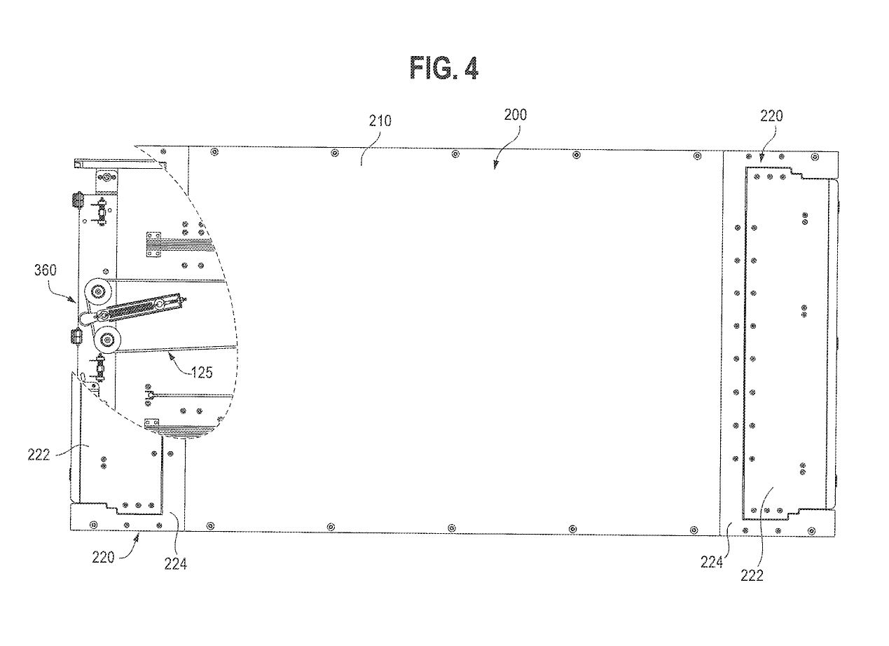

As shown in FIGS. 1 and 4, the dual deployment ramp 10 can further have a top plate assembly 200. The top plate assembly 200 can comprise a display plate 210 and a bridge roller plate assembly 220. The top plate assembly 200 provides a floor in the vehicle in which the dual deployment ramp 10 is installed. The top plate assembly 200 is aligned above the ramp assembly 100 when the ramp assembly is in the stowed position. At each longitudinal end of the top plate assembly, a bridge roller plate assembly 220 comprising a cover flap 222 and cover mount 224 is attached thereto. The cover flap 222 is pivotably attached to the cover mount 224.

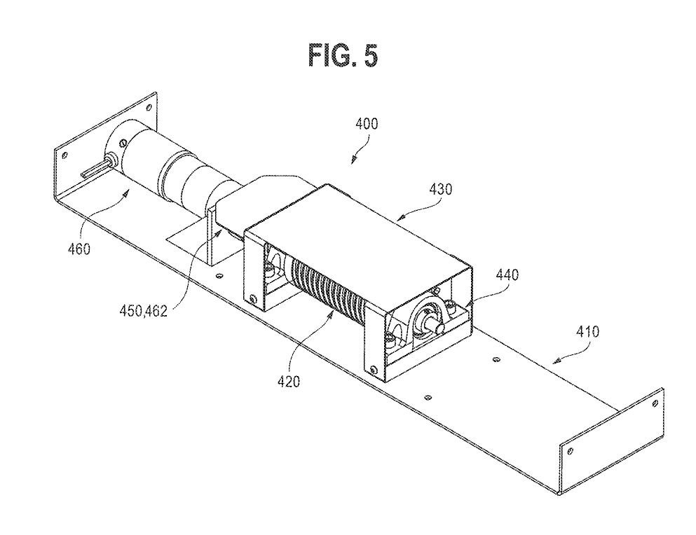

As shown in FIGS. 1 and 5, the dual deployment ramp 10 can further comprise a cable drum assembly 400 disposed below the ramp assembly 100. The cable drum assembly can comprise a motor mount weldment 410 with a motor 460 and cable drum 420 attached thereto. A cable drum cover 430 may also be positioned over the cable drum 420. Further, a motor shaft 462 may extend from the motor 460 and engage a shaft coupling 450 of the cable drum 420 such that the motor 460 engages the cable drum 420 to provide motion to the cable drum 420 to wind the slide cable 125. A pillow block 440 also provides bracing for the cable drum 420 to allow rotation.

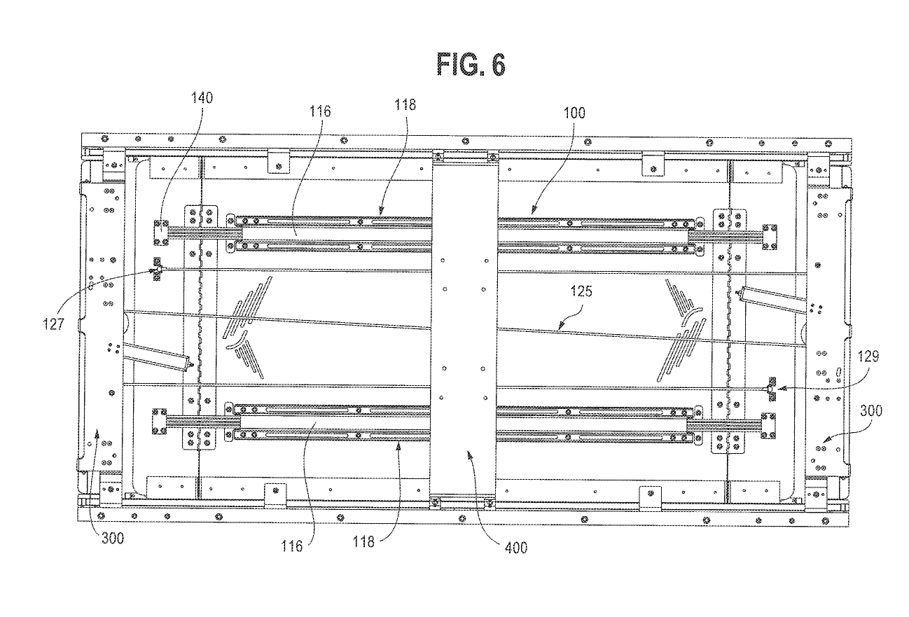

Referring now to FIG. 1 and FIG. 6, the positioning of the slide cable 125, the roller plate assembly 300, the cable drum assembly 400 and the underside of the ramp assembly 100 are shown relative to each other (FIG. 1 is an exploded view). The ramp assembly 100 slidably engages a rail guide 500 on each longitudinal edge of the ramp assembly via the rollers 114,124 of the mid-panel and end-panel side rails 112, 122. Further, the underside of the ramp assembly slidably engages the rollers 380 on the roller plate assembly 300. The ends 127, 129 of the slide cable 125 engages the slide cable attachment brackets 126 on each of the ramp end-panels 120. Starting at a first end 127, the slide cable 124 engages one of the slide cable attachment brackets 126. Next, the slide cable 124 extends to the pulley assembly 360 on one of the roller plate assemblies 300 and engages the pulleys 362 such that tension is applied to the slide cable 124 via the tension chute 364. Next, the slide cable 124 wraps around the cable drum 420 of the cable drum assembly 400 and then extends to engage the pulley assembly 360 on the opposite roller plate assembly 300 of the one already engaged by the slide cable 124. The tension chute 364 on this pulley assembly 360 maintains tension on the slide cable 124. Finally, the slide cable 124 extends towards to and attaches at its second end 129 with the remaining the slide cable attachment bracket 126 on the opposite ramp end-panel 120 from where the first end 127 of the slide cable 124 attached. At each of the roller plate assemblies 300, there is a cable saddle 320 positioned such that it helps guide the respective ends of the slide cable 124 towards the slide cable attachment brackets 126.

As the motor 460 is engaged, the cable drum 420 rotates such that the slide cable 124 is pulled in one direction at its first end 127 and pushed at the second end 129. Accordingly, the slide cable 124 pulls on the slide cable attachment bracket 126 at the first end 127. If the motor 460 is engaged in the opposite direction of rotation, the slide cable 124 is pulled at its second end 129 and pushed at the first end 127. Accordingly, the slide cable 124 pulls on the slide cable attachment bracket 126 at the second end 129. As a result, the ramp assembly 100 rolls via the mid-panel and end-panel rollers 114, 124 along the rail guide 500 in one direction or the other, depending on which of the slide cable attachment brackets 126 is pulled by the slide cable 124.

As the ramp assembly 100 reaches an end of the rail guides 500, the mid-panel 110 extends outward to the extent that only one of the end-panels 120 remains engaged by the rail guides 500. As a result, the mid-panel 110 and opposite end-panel collapse downward toward the ground (outside of the installed vehicle) due to gravity. As it collapses downward, each of the spring loaded, pivotable connections between the mid- and end-panels collapses. Once the motor 460 is reversed, causing the ramp assembly 100 to begin its movement back into position below the top plate assembly 200, the rail guides 500 again engage the mid-panel 110 causing the end-panels 120 to return to their initial positions (horizontal to the top plate assembly 200). As pressure is relieved on each of the spring loaded connections, the end-panels return to their linear alignment with the mid-panel. The exact opposite movements are achieved when the ramp assembly 100 is deployed in the opposite direction from the other side of the installed vehicle. Thus, the ramp is a dual deployment system.

Another feature of the disclosed dual deployment ramp is that the top plate assembly 200 is designed such that the cover flap 222 of the bridge roller plate assembly 220 maintains a consistent horizontal position for the top plate assembly 200 at the opposite side of deployment while the opposite cover flap 222 on the side of ramp assembly 100 deployment pivots downward to provide a streamlined and manageable angle to the ramp assembly 100 from the display plate 210 for a wheelchair to roll downwards toward the ground. The cover flap 222 on the opposite side of deployment is able to remain horizontally positioned by way of the kick stand blocks 330 extending into a vertical position via the kick stand springs 350 (e.g., torsion springs) once the ramp assembly 100 slides away from the respective roller plate assembly 300, resulting in the kick stand blocks 330 engaging the underside of the cover flap 222. Once the ramp assembly 100 is retracted into the stowed position, the end-panel 120 of the ramp assembly 100 strikes and moves over the kick stand blocks 330, causing the kick stand springs 350 to compress and kick stand blocks 330 return to the retracted position.

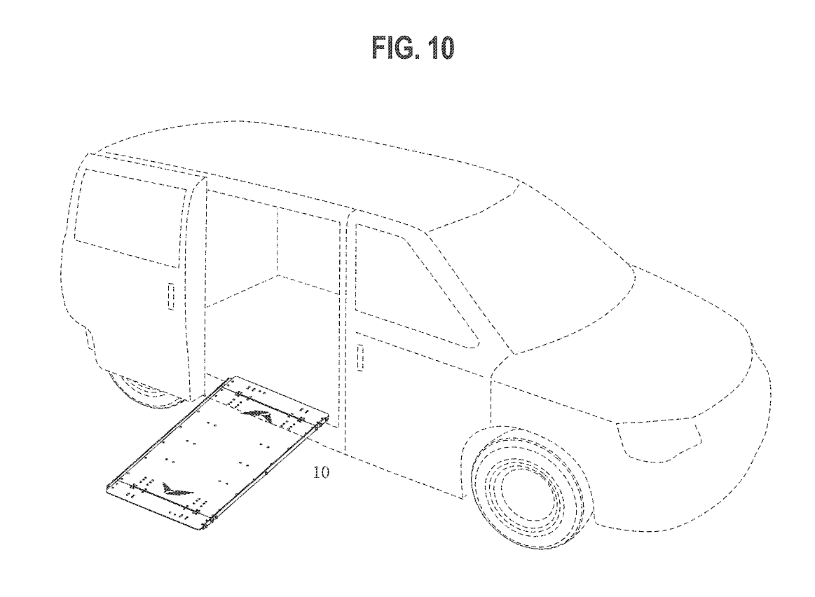

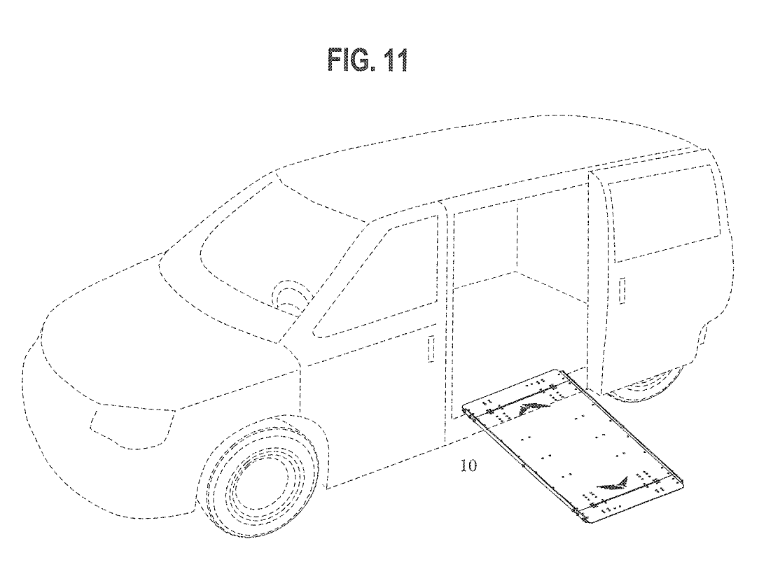

FIG. 10 shows a dual deployment ramp 10 of the present disclosure as deployed on the passenger side of a vehicle. FIG. 11 shows a dual deployment ramp 10 of the present disclosure as deployed on the driver side of a vehicle. The vehicle illustrated in FIGS. 10 and 11 may be the same vehicle configured with doors that open on each side of the passenger compartment to allow the dual deployment ramp 10 to deploy on either side of the vehicle.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application and the scope of the appended claims.

We claim:

1. A dual deployment ramp for a vehicle, comprising:
a ramp assembly, the ramp assembly comprising a mid-panel and a first and second end-panel, the end-panels pivotably attached to opposite ends of the mid-panel;
a slide cable comprising a first and second end, the first end engaging the first end-panel and the second end engaging the second end-panel;
opposing roller plate assemblies comprising one or more pulleys for engagement of the slide cable, the roller plate assemblies positioned below the ramp assembly and at each end thereof below the respective first and second end-panel; and
a cable drum assembly positioned below the ramp assembly and between the opposing roller plate assemblies, the cable drum assembly comprising a cable drum engaging the slide cable to provide reversible movement to the slide cable for pulling one of the first and second end-panels to move the ramp assembly in one of opposing directions for providing dual deployment.

2. The dual deployment ramp of claim 1, further comprising a top plate assembly positioned above the ramp assembly when the ramp assembly is in a stowed position.

3. The dual deployment ramp of claim 2, wherein the ramp assembly is capable of deploying from underneath either longitudinal end of the top plate assembly.

4. The dual deployment ramp of claim 1, further comprising one or more mid-panel side rails positioned on the outer edges of the mid-panel and running substantially the longitudinal length of the mid-panel.

5. The dual deployment ramp of claim 1, further comprising one or more end-panel side rails positioned on the outer edges of each of the end-panels.

6. The dual deployment ramp of claim 1, further comprising one or more ramp support on the underside of the mid-panel and running substantially the longitudinal length of the mid-panel.

7. The dual deployment ramp of claim 6, further comprising one or more slide plate disposed on each of the one or more ramp support.

8. The dual deployment ramp of claim 6, further comprising one or more positioning spring extending outwards from each end of the ramp support to respective end-panels.

9. The dual deployment ramp of claim 1, wherein the end-panels are pivotably attached to opposite ends of the mid-panel via one or more spring loaded hinge.

10. A vehicle comprising the dual deployment ramp of claim 1.

11. A dual deployment ramp system for a vehicle, comprising:
a ramp assembly, the ramp assembly comprising a mid-panel and a first and second end-panel, the end-panels pivotably attached to opposite ends of the mid-panel;
a slide cable comprising a first and second end, the first end engaging the first end-panel and the second end engaging the second end-panel;
opposing roller plate assemblies comprising one or more pulleys for engagement of the slide cable, the roller plate assemblies positioned below the ramp assembly and at each end thereof below the respective first and second end-panel; and
a cable drum assembly positioned below the ramp assembly and between the opposing roller plate assemblies, the cable drum assembly comprising a cable drum driven by a reversible motor, the cable drum engaging the slide cable to provide reversible movement to the slide cable for pulling one of the first and second end-panels to move the ramp assembly in one of opposing directions for providing dual deployment.

12. The dual deployment ramp system of claim 11, further comprising a top plate assembly positioned above the ramp assembly when the ramp assembly is in a stowed position.

13. The dual deployment ramp system of claim 12, wherein the ramp assembly is capable of deploying from underneath either longitudinal end of the top plate assembly.

14. The dual deployment ramp system of claim 11, further comprising one or more mid-panel side rails positioned on the outer edges of the mid-panel and running substantially the longitudinal length of the mid-panel.

15. The dual deployment ramp system of claim 11, further comprising one or more end-panel side rails positioned on the outer edges of each of the end-panels.

16. The dual deployment ramp system of claim 11, further comprising one or more ramp support on the underside of the mid-panel and running substantially the longitudinal length of the mid-panel.

17. The dual deployment ramp system of claim 16, further comprising one or more slide plate disposed on each of the one or more ramp support.

18. The dual deployment ramp system of claim 16, further comprising one or more positioning spring extending outwards from each end of the ramp support to respective end-panels.

19. The dual deployment ramp system of claim 11, wherein the end-panels are pivotably attached to opposite ends of the mid-panel via one or more swing loaded hinge.

20. A vehicle comprising the dual deployment ramp system of claim 11.
